(19) United States
(12) Patent Application Publication
(10) Pub. No.: US 2009/0215542 A1
(43) Pub. Date: Aug. 27, 2009

(54) GAME PROGRAM, GAME DEVICE, AND GAME CONTROL METHOD

(75) Inventor: Kazuya TAKAHASHI, Kouhoku-ku (JP)

Correspondence Address: GLOBAL IP COUNSELORS, LLP, 1233 20TH STREET, NW, SUITE 700, WASHINGTON, DC, 20036-2680, US

(73) Assignee: KONAMI DIGITAL ENTERTAINMENT CO., LTD., Tokyo (JP)

(21) Appl. No.: 12/369,920

(22) Filed: Feb. 12, 2009

(30) Foreign Application Priority Data
Feb. 22, 2008 (JP) 2008-041779

(51) Int. Cl. A63F 9/24; A63F 13/00

(52) U.S. Cl. 463/43; 463/37

(57) ABSTRACT

It is an object of the present invention to allow a character to prepare for participating in a match-up event. The present program is configured to execute processing of controlling a match-up event in a game. A first character in the match-up event is displayed on a first screen with first character's image data. Then, a second character standing by for participating in the match-up event is recognized by a control unit with second character's recognition data. Next, a preparation start command is issued by the control unit for causing the second character to start preparation for participating in the match-up event. When the preparation start command is issued by the control unit, a second character preparing for participating in the match-up event is displayed on a second screen with second character's image data.

### CROSS-REFERENCE TO RELATED APPLICATIONS

This application claims priority under 35 U.S.C. §119 to Japanese Patent Application No. 2008-041779 filed on Feb. 22, 2008. The entire disclosure of Japanese Patent Application No. 2008-041779 is hereby incorporated herein by reference.

### BACKGROUND OF THE INVENTION

1. Field of the Invention

The present invention generally relates to a game program, and more specifically to a game program for realizing a game that a character is displayed on an image display unit. In addition, the present invention relates to a game device configured to be capable of executing the game program, and a game control method to be controlled by a computer based on the game program.

A variety of video games have been conventionally proposed. The video games are executed in a game device. For example, a game device generally includes a monitor, a game console, and an input unit (e.g., a game controller). Here, the game console is provided separately from the monitor. The input unit is provided separately from the game console. A plurality of input buttons are arranged on the game controller. For example, when the game device is a portable game device, it includes a game console, a liquid-crystal display (LCD) monitor, and input units (e.g., a plurality of input buttons). In this case, the LCD monitor is arranged in the approximately center part of the game console. The input units are arranged on the both sides of the LCD monitor.

A baseball video game is known as one of the video games to be executed by the above-mentioned game devices. An example of the baseball video game is software for PlayStation®2, “Jikkyo Powerful Major League 2” of Konami Digital Entertainment Co., Ltd. on sale in Oct. 4, 2007. The baseball video game is capable of executing a variety of modes (e.g., a match-up mode and a coach mode). In the match-up mode, a game player selects a baseball team, operates baseball player characters of the selected team, and competes with an opponent team for getting scores. In the coach mode, a game player participates in a baseball match as a coach of his/her selected team, and the baseball match is mainly automatically performed.

For example, the match-up mode is capable of causing a batter character to swing a bat, causing a pitcher character and a fielder character to release a ball, and the like, when a game player gives a baseball player character an instruction of motion while the team selected by the game player takes an offensive/defensive position in a baseball match event. Also, the much-up mode is capable of changing the batter character, the pitcher character, and the fielder character when a game player gives an instruction of tactics for the baseball match event through a game controller.

As described above, with a variety of instructions, the game player is capable of causing a baseball player character to perform a variety of motions and realizing his/her desired tactics in the baseball match event.

In the conventional baseball video game, a variety of instructions are performed by a game player in the baseball match event when the match-up mode is executed.

One of a variety of instructions performed by a game player is a pitcher replacement instruction for relieving a pitcher character. When a game player performs the pitcher replacement instruction depending on a state of the baseball match, a list of reserve pitcher characters is displayed on a display monitor. Then, when a game player's desired pitcher character is selected from the list, the selected reserve pitcher character is displayed on the display monitor instead of the pitcher character having taken the mound so far. In other words, it is possible to cause the selected reserve pitcher character to take the mound instead of the pitcher character having taken the mound so far.

On the other hand, with the increasing number of game players enjoying baseball video games, the game players gradually demanded a baseball video game for allowing them to experience a feeling of the real baseball. In response to this, a game provider has undertaken development of a baseball video game for allowing a game player to play the video game with maximally the same feeling as feeling to be experienced in the real baseball. In the process of development of the baseball video game, differences have been found between the baseball video game and the real baseball.

For example, in the real baseball, a reserve pitcher warms up at the bullpen before a pitcher taking the mound is replaced by the reserve pitcher. In general, when the reserve pitcher is ready for taking the mound, instruction of relieving a pitcher is given. In other words, the pitcher replacement instruction is given while not only the state of a baseball match but also the reserve pitcher's condition is taken into consideration. As described above, the conventional baseball video game has been capable of performing the pitcher replacement instruction in accordance with the state of a baseball match. However, the conventional baseball video game is not configured to be capable of causing a reserve pitcher to warm up at the bullpen and giving a pitcher replacement instruction in consideration of a reserve pitcher's condition.

Accordingly, aspects of the present invention have been created to solve the above-mentioned problems occurring in the conventional practice, and to allow a character to prepare for participating in a match-up event. Also, aspects of the present invention have been created to replace a character with another character in consideration of a condition of the latter character to replace the former character.

### SUMMARY OF THE INVENTION

A first aspect of the present invention relates to a program for causing a computer to realize the following functions. Note that the computer is capable of executing a game of displaying a character on an image display unit. The functions are:
(1) A match-up event control function for causing a control unit to execute processing of controlling a match-up event in the game;
(2) A first display function for displaying a first character in the match-up event on a first screen with first character's image data;
(3) A second character recognition function for causing the control unit to recognize a second character standing by for participating in the match-up event with second character's identification data;
(4) A preparation start command issue function for causing the control unit to issue a preparation start command for causing the second character to start preparation for participating in the match-up event; and
(5) A second display function for displaying the second character preparing for participating in the match-up event on a second screen with second character's image data when the control unit issues the preparation start command.

According to the game program, in the match-up event control function, the control unit executes processing of controlling a match-up event in the game. In the first display function, the first character in the match-up event is displayed on the first screen with first character's image data. In the second character recognition function, the control unit recognizes a second character standing by for participating in the match-up event with second character's identification data. In the preparation start command issue function, the control unit issues a preparation start command for causing the second character to start preparation for participating in the match-up event. In the second display function, the second character preparing for participating in the match-up event is displayed on a second screen with second character's image data when the control unit issues the preparation start command.

For example, when a baseball video game is executed with the present game program, the control unit executes processing of controlling a match-up event in the baseball video game. Here, a pitcher character on the mound in the match-up event is displayed on a baseball match screen with pitcher character's image data. Also, the control unit recognizes a reserve pitcher character standing by on the bench for replacement in the match-up event with pitcher character's identification data. Furthermore, the control unit issues a preparation start command for causing a pitcher character to start preparation for replacement in the match-up event. Accordingly, a reserve pitcher character preparing for replacement in the match-up event is displayed on a bullpen screen with pitcher character's image data.

In this case, when the control unit executes the match-up event, the pitcher character on the mound is displayed on the baseball match screen. Also, when the control unit issues the preparation command to the reserve pitcher character standing by on the bench for replacement in the match-up event (i.e., a reserve pitcher character) for causing the reserve pitcher character to start preparation replacement in the match-up event, a series of motions (i.e., a series of warm-up motions at the bullpen) of the reserve pitcher character that the preparation start command was given is displayed on the bullpen screen.

According to the first aspect of the present invention, it is thus possible to cause the reserve pitcher character to warm up by giving the reserve pitcher character a command for starting preparation for replacement (i.e., a preparation start command) while another pitcher character is on the mound in the match-up event. In other words, it is possible to cause the reserve pitcher character to prepare for replacement in the match-up event.

Also, it is possible to easily distinguish the pitcher character on the mound and the reserve pitcher character preparing for replacement by differently setting a screen for displaying the pitcher character on the mound (a baseball match screen) and a screen for displaying the reserve pitcher character preparing for replacement (a bullpen screen). Also, it is possible to easily watch and confirm the reserve pitcher character preparing for replacement.

Generally expressed, this means that it is possible to cause a character to prepare for participating in a match-up event. Also, this means that it is possible to easily watch and confirm a character preparing for participating in a match-up event.

A second aspect of the present invention relates to the game program of the first aspect. The game program of the second aspect realizes the following functions:
(6) A match-up event participation command issue function for causing the control unit to issue a match-up event participation command for causing the second character preparing for participating in the match-up event to participate in the match-up event; and
(7) A third display function for displaying the second character preparing for participating in the match-up event on the first screen with the second character's image data when the control unit issues the match-up event participation command.

According to the game program, in the match-up event participation command issue function, the control unit issues the match-up event participation command for causing the second character preparing for participating in the match-up event to participate in the match-up event. In the third display function, the second character preparing for participating in the match-up event is displayed on the first screen with the second character's image data when the control unit issues the match-up event participation command.

For example, when a baseball video game is executed with the present game program, the control unit issues a match-up event participation command for causing a reserve pitcher character preparing for replacement to participate in a match-up event. Accordingly, the reserve pitcher character having prepared for replacement in the match-up event is displayed on a baseball match screen with the pitcher character's image data.

In this case, when a pitcher replacement command for relieving a pitcher character on the mound (i.e., a match-up event participation command) is given while a reserve pitcher character warms up, the reserve pitcher character having prepared for replacement in the match-up event is displayed on the baseball match screen instead of the pitcher character having been on the mound.

According to the second aspect, it is thus possible to cause the reserve pitcher character preparing for replacement in the match-up event to be on the mound instead of the pitcher character being on the mound by giving the match-up event preparation command while the reserve pitcher character warms up. In other words, it is possible to cause the reserve pitcher character preparing for replacement in the match-up event to be on the mound. Generally expressed, this means that it is possible to cause a character preparing for participating in a match-up event to participate in the match-up event.

A third aspect of the present invention relates to the game program of one of the first and second aspects. The game program of the third aspect realizes the following functions:
(8) A preparation pause command issue function for causing the control unit to issue a preparation pause command for causing the second character to pause preparation for participating in the match-up event; and
(9) A display clearance function for causing the control unit to issue a character clearance command for clearing the second character preparing for participating in the match-up event form the second screen when the control unit issues the preparation pause command.

According to the game program, in the preparation pause command issue function, the control unit issues the preparation pause command for causing the second character to pause preparation for participating in the match-up event. In the display clearance function, the control unit issues the character clearance command for clearing the second character preparing for participating in the match-up event form the second screen when the control unit issues the preparation pause command.

For example, when a baseball video game is executed with the present game program, the control unit issues a preparation pause command for causing a reserve pitcher character preparing for replacement in a match-up event to take a break from preparation. Accordingly, the control unit issues a character clear command for clearing the reserve pitcher character preparing for replacement in the match-up event from a bullpen screen.

In this case, the control unit issues a command for pause ping preparation for replacement (i.e., a preparation pause command) for getting a reserve pitcher character preparing for replacement in the match-up event back to the bench while the reserve pitcher character warms up. Accordingly, the reserve pitcher character preparing for replacement in the match-up event is cleared from the bullpen screen.

According to the third aspect, it is thus possible to get the reserve pitcher character preparing for replacement in the match-up event back to the bench from the bullpen by giving the preparation pause command while the reserve pitcher character warms up. In other words, it is possible to cause the reserve pitcher character preparing for replacement in the match-up event to take a break from preparation. Generally expressed, this means that it is possible to cause a character preparing for participating in a match-up event to take a break from preparation.

A fourth aspect of the present invention relates to the game program of one of the first to third aspects. The game program of the fourth aspect realizes the following functions:
(10) A preparation condition data recognition function for causing the control unit to recognize a preparation condition of the second character preparing for participating in the match-up event with second character's preparation condition data when the control unit issues the participation start command; and
(11) A preparation condition display function for displaying a preparation condition of the second character preparing for participating in the match-up event on at least either the first screen or the second screen with preparation condition's image data based on second character's preparation condition data.

According to the game program, in the preparation condition data recognition function, the control unit recognizes the preparation condition of the second character preparing for participating in the match-up event with the second character's preparation condition data when the control unit issues the preparation start command. In the preparation condition display function, the preparation condition of the second character preparing for participating in the match-up event is displayed on at least either the first screen or the second screen with the preparation condition's image data based on the second character's preparation condition data.

For example, when a baseball video game is executed with the game program, the control unit recognizes a preparation condition of a reserve pitcher character preparing for replacement in the match-up event with the pitcher character's preparation condition data when the control unit issues the preparation start command. Then, based on the pitcher character's preparation condition data, the preparation condition of the reserve pitcher character preparing for replacement in the match-up event is displayed on at least either the baseball match screen or the bullpen screen with the preparation condition's image data.

In this case, when the control unit issues the preparation start command for staring preparation for replacement in the match-up event, an image for showing the preparation condition of the pitcher character that the preparation start command was given is displayed on at least either the baseball match screen or the bullpen screen with the preparation condition's image data.

As described above, according to the fourth aspect, when a command for starting preparation for replacement (i.e., the preparation start command) is given to a reserve pitcher character, an image for showing the preparation condition of the reserve pitcher character (e.g., an image of a gauge for showing a preparation condition of the reserve pitcher character) is displayed on at least either the baseball match screen or the bullpen screen. Accordingly, a game player is capable of judging a preparation level of the reserve pitcher character by watching the gauge image. Generally expressed, this means that it is possible to determine a preparation condition of a character preparing for participating in a match-up event based on an image for showing the preparation condition.

A fifth aspect of the present invention relates to the game program of the fourth aspect. The game program of the fifth aspect realizes the following function:
(12) A first preparation condition data change function for causing the control unit to execute processing of changing the preparation condition data of the second character preparing for participating in the match-up event in conjunction with a motion of the first character.

According to the game program, in the first preparation condition data change function, the control unit executes processing of changing the preparation condition data of the second character preparing for participating in the match-up event in conjunction with a motion of the first character.

In other words, the second character's preparation condition does not independently change from the first character's motion, but changes in conjunction with the first character's motion. A game player is capable of predicting a general preparation condition of the second character which changes in conjunction with the first character's motion only by confirming the first character's motion. Therefore, a game player does not need to frequently confirm the second screen displaying the second character's preparation during the match-up between the first character and the second character. In other words, a game player just needs to confirm the first character's motion state and then confirm the second screen at the timing when he/she guesses that the second character is completely prepared. Here, the term “conjunction” means that the first character and the second character perform completely the same motion and perform motions at the same frequency. In addition to this, the term “conjunction” means a constantly-configured relation that the second character performs a motion once when the first character performs a motion twice.

A sixth aspect of the present invention relates to the game program of the fifth aspect. In the game program of the sixth aspect, the first character is a pitcher character on the mound in a baseball video game. Also, the second character is a reserve pitcher character in the baseball video game. Furthermore, in the first preparation condition data change function, the control unit executes processing of changing the preparation condition data of the reserve pitcher character preparing for participating in the match event based on an assumption that the reserve pitcher character preparing for participating in the match-up event has performed a pitching motion at the same frequency as a pitching motion of the pitcher character on the mound.

In this case, the control unit executes processing of changing the preparation condition data of a reserve pitcher character preparing for replacement in the match-up event with use of a pitching motion of a pitcher character on the mound (e.g., the number of pitches released by the pitcher character on the mound) instead of the number of pitches released by a reserve pitcher character preparing for participating in the match-up event.

For example, the preparation condition of a pitcher character is evaluated in conjunction with the number of pitches released by a pitcher character on the mound based on the relation that the number of pitches released by a reserve pitcher character preparing for replacement is increased in proportion to the increasing number of pitches released by a pitcher character on the mound. In other words, the preparation condition of a reserve pitcher character preparing for replacement is determined to be better in proportion to the increasing number of pitches released by a pitcher character on the mound.

Accordingly a game player is capable of predicting a preparation condition of a reserve pitcher character preparing for replacement by grasping the number of pitches released by a pitcher character on the mound after the preparation start command is given to the reserve pitcher character. For example, even when a game player executes the match-up mode in a match-up event while a reserve pitcher character warming up at the bullpen is not being displayed on the screen, the game player is capable of predicting a preparation condition of the reserve pitcher character warming-up at the bullpen by grasping the number of pitches released by a pitcher character on the mound.

According to the sixth aspect, it is thus possible to relieve a pitcher character on the mound in consideration of a preparation state of a reserve pitcher character preparing for replacement. Generally expressed, this means that it is possible to replace a character with another character in consideration of a condition of the latter character to replace the former character.

A seventh aspect of the present invention relates to the game program of one of the fifth and sixth aspects. In the game program of the seventh aspect, the first character is a pitcher character on the mound in a baseball video game. Also, the second character is a reserve pitcher character in the baseball video game. Furthermore, in the first preparation condition data change function, the control unit determines if a motion of the pitcher character on the mound is a pitching motion with respect to a batter character or a pickoff motion with respect to a fielder character. Then, when the motion of the pitcher character on the mound is the pitching motion, the control unit executes processing of changing the preparation condition data of the reserve pitcher character preparing for participating in the match-up event in conjunction with the pitching motion of the pitcher character on the mound. On the other hand, when the motion of the pitcher character on the mound is the pickoff motion, the control unit executes processing of maintaining the preparation condition data of the reserve pitcher character preparing for participating in the match-up event.

Here, when the pitcher character on the mound releases a ball object toward a batter character, the preparation condition data of the reserve pitcher character preparing for replacement in the match-up event is changed in conjunction with the number of pitches released by the pitcher character on the mound. For example, the preparation condition data of the reserve pitcher character preparing for replacement is changed to be better in proportion to the increasing number of pitches released by the pitcher character on the mound. On the other hand, when the motion of the pitcher character on the mound is the pickoff motion, the preparation condition data of the reserve pitcher character preparing for participating in the match-up event is not changed. In other words, the preparation condition data of the reserve pitcher character preparing for replacement in the match-up event is changed to be better only when the pitcher character on the mound releases a ball object toward a batter character.

Accordingly, a game player is not capable of enhancing the preparation condition of the reserve pitcher character warming up at the bullpen by repeatedly causing the pitcher character on the mound to make a pickoff throw, for instance. More specifically, a game player is not capable of enhancing only the preparation condition of the reserve pitcher character warming up at the bullpen without a match-up between the pitcher character on the mound and the batter character while the game player gives a pitching command to the pitcher character on the mound.

According to the seventh invention, the preparation condition of the reserve pitcher character warming up at the bullpen is not changed with a method departing from the original form. In other words, the preparation condition of the reserve pitcher character warming up at the bullpen is changed only with the original form of a baseball video game.

An eighth aspect of the present invention is the game program of one of the fourth to seventh aspects. The game program of the eighth aspect realizes the following functions:
(13) A preparation pause command issue function for causing the control unit to issue a preparation pause command for causing the second character to pause preparation for participating in the match-up event; and
(14) A second preparation condition data change function for causing the control unit to execute processing of changing the preparation condition data of the second character preparing for participating in the match-up event in conjunction with a motion of the first character after the control unit issues the preparation pause command.

According to the game program, in the preparation pause command issue function, the control unit issues the preparation pause command for causing the second character to pause preparation for participating in the match-up event. Furthermore, in the second preparation condition data change function, the control unit executes preparation of changing the preparation condition data of the second character preparing for participating in the match-up event in conjunction with a motion of the first character after the control unit issues the preparation pause command.

For example, when a baseball video game is executed with the present game program, the control unit issues a preparation pause command for causing the pitcher character to take a break from preparation for replacement in the match-up event. Accordingly, the control unit executes processing of changing the preparation condition data of a reserve pitcher character preparing for participating in the match-up event in conjunction with a motion of a pitcher character on the mound (e.g., the number of pitches released by a pitcher character on the mound) after the control unit issues the preparation pause command. Specifically, the control unit executes processing of changing the preparation condition data of the reserve pitcher character preparing for participating in the match-up event to be smaller in conjunction with the number of pitches released by the pitcher character on the mound.

In this case, when the reserve pitcher character preparing for replacement in the match-up event goes back to the bench and takes a break, the control unit executes processing of changing the preparation condition data of the reserve pitcher character having prepared for replacement in the match-up event in conjunction with the number of pitches released by the pitcher character on the mound Specifically, when the reserve pitcher character preparing for replacement in the match-up event takes a break from preparation, the control unit executes processing of changing the preparation condition data of the pitcher character having prepared for replacement to be smaller in conjunction with the number of pitches released by the pitcher character on the mound.

For example, once the reserve pitcher character preparing for replacement in the match-up event takes a break from preparation, the body (e.g., the shoulder) of the reserve pitcher character taking a break from preparation cools down in proportion to the increasing period of break time. In this case, a period of break time of the pitcher character is evaluated with the number of pitches released by the pitcher character on the mound.

Accordingly, when a game player causes the reserve pitcher character warming up at the bullpen to take a break from preparation, the game player is capable of predicting the preparation condition of the reserve pitcher character taking a break from preparation by grasping the number of pitches released by the pitcher character on the mound after the preparation pause command is given to the reserve pitcher character warming up at the bullpen. For example, even when a game player executes the match-up mode in a match-up event while a reserve pitcher character taking a break from warm-up at the bullpen is not being displayed on the screen, the game player is capable of predicting the preparation condition of the reserve pitcher character taking a break by grasping the number of pitches released by the pitcher character on the mound.

According to the eighth aspect, it is thus possible to relieve the pitcher character on the mound in consideration of a condition of the reserve pitcher character standing by for replacement while taking a break from preparation. Generally expressed, this means that it is possible to replace a character with another character in consideration of a condition of the latter character to replace the former character.

A ninth aspect of the present invention relates to the game program of one of the fourth to eighth aspects. The game program of the ninth aspect realizes the following functions:
(15) A property data recognition function for causing the control unit to recognize a property of the second character preparing for participating in the match-up event with second character's property data; and
(16) A property data change function for causing the control unit to execute processing of changing property data of the second character preparing for participating in the match-up event in conjunction with a motion of the second character preparing for participating in the match-up event when the preparation condition data of the second character reaches a predetermine value.

According to the game program, in the property data recognition function, the control unit recognizes the property of the second character preparing for participating in the match-up event with the second character's property data. Furthermore, in the property data change function, the control unit executes processing of changing the property data of the second character preparing for participating in the match-up event in conjunction with a motion of the second character preparing for participating in the match-up event when the preparation condition data of the second character reaches a predetermined value.

For example, when a baseball video game is executed with the present game program, the control unit recognizes an ability property of the reserve pitcher character preparing for replacement in the match-up event with the ability property data of the pitcher character. Then, when the pitcher character's preparation condition data reaches a predetermined value, the control unit executes processing of changing the ability property data of the reserve pitcher character preparing for replacement in the match-up event in conjunction with a motion of the reserve pitcher character preparing for replacement in the match-up event (e.g., the number of pitches released by the reserve pitcher character preparing for replacement).

In this case, when the pitcher character's preparation condition data reaches a predetermined value, the control unit executes processing of changing the ability property data of the reserve pitcher character preparing for replacement in the match-up event in conjunction with the number of pitches released by the reserve pitcher character preparing for replacement in the match-up event. Specifically, when the preparation condition of the reserve pitcher character preparing for replacement in the match-up event reaches a completely prepared condition, the control unit executes processing of changing the ability property data of the reserve pitcher character preparing for replacement in the match-up event to be smaller.

For example, when the preparation condition of the reserve pitcher character preparing for replacement in the match-up event reaches a completely prepared condition and then the completely prepared pitcher character is caused to further prepare for replacement, the reserve pitcher character gets tired and an ability property of the reserve pitcher character (e.g., toughness property) is reduced. In this case, the additional preparation performed by the already-completely-prepared pitcher character is evaluated with the number of pitches released by the pitcher character on the mound.

Accordingly, a game player needs to play the match-up mode not only by simply giving the preparation start command to the reserve pitcher character, but also by always considering a preparation condition level of the reserve pitcher character performing preparation after the game player gives the preparation start command to the reserve pitcher character. In other words, a game player needs to play the match-up mode while always predicting a preparation condition of the reserve pitcher character performing preparation by grasping the number of pitches released by the pitcher character on the mound after the preparation start command is given to the reserve pitcher character.

With the above mentioned playing method, a game player is capable of relieving a pitcher character at the optimum timing. In other words, a game player is capable of replace a pitcher character on the mound with a best-conditioned reserve pitcher character while playing the baseball video game in consideration of the condition of the reserve pitcher character performing preparation. Generally expressed, this means that it is possible to replace a character with another character on the best condition while the video game is played in consideration of a state of the latter character to replace the former character.

A tenth aspect of the present invention relates to a game device being capable of executing a game of displaying a character on an image display unit. The game device includes match-up event control means, first display means, second character recognition means, preparation start command issue means, and second display means. The match-up event control means causes a control unit to execute processing of controlling a match-up event in the game. The first display means displays a first character in the match-up event on a first screen with first character's image data. The second character recognition means for causing the control unit to recognize a second character standing by for participating in the match-up event with second character's identification data. The preparation start command issue means is for causing the control unit to issue a preparation start command for causing the second character to start preparation for participating in the match-up event. The second display means is displaying the second character preparing for participating in the match-up event on a second screen with second character's image data when the control unit issues the preparation start command.

An eleventh aspect of the present invention relates to a game control method for allowing a computer to control a game of displaying a character on an image display unit. The game control method includes the steps of: causing a control unit to execute processing of controlling a match-up event in the game; displaying a first character in the match-up event on a first screen with first character's image data; causing the control unit to recognize a second character standing by for participating in the match-up event with second character's identification data; causing the control unit to issue a preparation start command for causing the second character to start preparation for participating in the match-up event; and displaying the second character preparing for participating in the match-up event on a second screen with second character's image data when the control unit issues the preparation start command.

According to the present invention, it is possible to cause a character (former character) to prepare for participating in a match-up event by giving the character a command for starting preparation for participating in the match-up event while another character (latter character) performs a motion in the match-up event. In other words, it is possible to cause the former character to perform preparation before participating in the match-up event. Also, according to the present invention, it is possible to predict a preparation condition of a character performing preparation (former character) by grasping an operation of another character participating in a match-up event (latter character). Accordingly, it is possible to relieve the character participating in the match-up event (latter character) by another character (former character) in a good condition.

### BRIEF DESCRIPTION OF THE DRAWINGS

Referring now to the attached drawings which form a part of this original disclosure:

FIG. 1 is a block diagram for illustrating a basic configuration of a video game device in accordance with an embodiment of the present invention;

FIG. 2 is a functional block diagram for illustrating an example of the video game device;

FIG. 3 is a diagram for illustrating a screenshot of a baseball match;

FIG. 4 is a diagram for illustrating an interrupt screen (a screenshot of interrupt command's list);

FIG. 5 is a diagram for illustrating a screenshot of a bullpen;

FIG. 6 is a table for illustrating relations among the number of pitches, warm-up condition data, and toughness data;

FIG. 7 is a flowchart for illustrating summary of the entire baseball video game;

FIG. 8A is a flowchart for illustrating a warm-up system in the baseball video game;

FIG. 8B is a flowchart for illustrating a warm-up system in the baseball video game;

FIG. 8CA is a flowchart for illustrating a warm-up system in the baseball video game; and

FIG. 8D is a flowchart for illustrating a warm-up system in the baseball video game.

### DETAILED DESCRIPTION OF THE EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### Configuration and Operation of Game Device

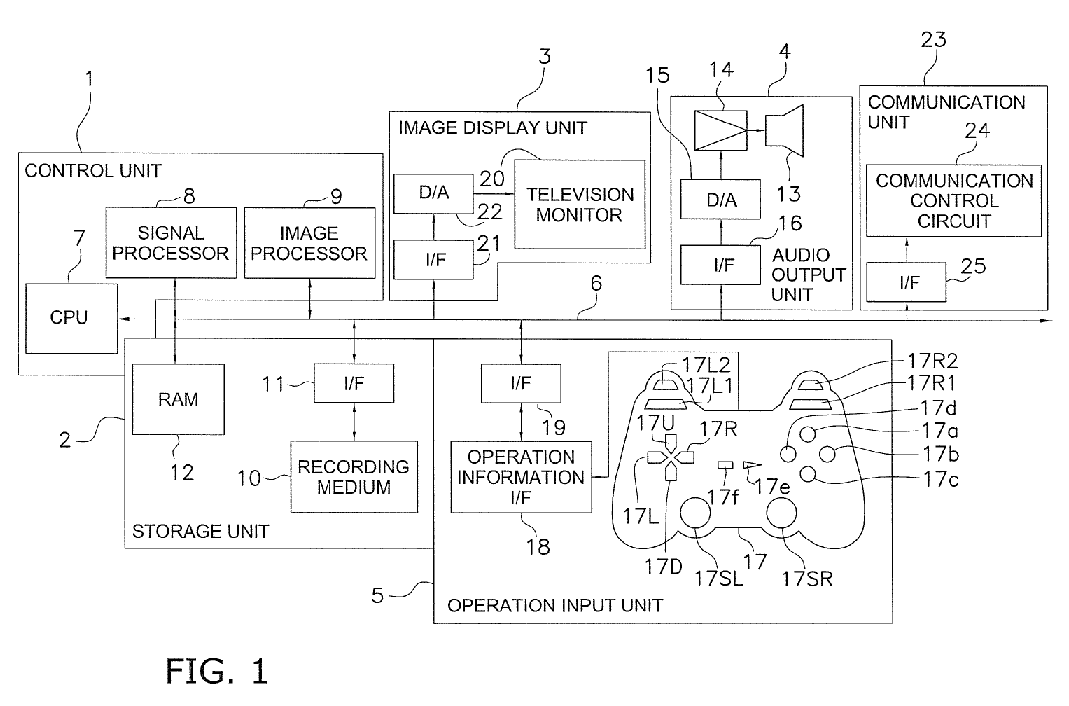

FIG. 1 illustrates the basic configuration of a game device in accordance with an embodiment of the present invention. As an example of a video game device, a home video game device will be hereinafter explained. The home video game device includes a home video game console and a home television set. A recording medium 10 is allowed to be loaded in the home video game console. Game data is arbitrarily read out of the recording medium 10 and a game is executed. The content of the game executed herewith is displayed on the home television set.

The game system of the home video game device is made up of a control unit 1, a storage unit 2, an image display unit 3, an audio output unit 4, and an operation input unit 5. These units are connected to each other through a bus 6, respectively. This bus 6 includes an address bus, a data bus, a control bus, and the like. Here, the control unit 1, the storage unit 2, the audio output unit 4, and the operation input unit 5 are included in the home video game console of the home video game device, and the image display unit 3 is included in the home television set.

The control unit 1 is provided for mainly controlling the state of the entire game based on the game program. For example, the control unit 1 is made up of a CPU (Central Processing Unit) 7, a signal processor 8, and an image processor 9. The CPU 7, the signal processor 8, and the image processor 9 are connected to each other through the bus 6. The CPU 7 interprets a command from a game program and executes a variety of data processing and data control. For example, the CPU 7 commands the signal processor 8 to provide the image data to the image processor. The signal processor 8 mainly executes computations in the three-dimensional space, position conversion computations from the three-dimensional space to a virtual three-dimensional space, light source computation processing, and data generation and data processing of image data and audio data. The image processor 9 mainly executes processing of writing image data on a RAM (Random Access Memory) 12 based on the computation results and processing results of the signal processor 8. Note that the image data written in the RAM 12 will be subsequently rendered.

The memory unit 2 is provided mainly for storing the program data, various types of data used for the program data, and the like. For example, the storage unit 2 is made up of the recording medium 10, an interface circuit 11, and the RAM 12, for instance. The interface circuit 11 is connected to the recording medium 10. The interface circuit 11 and the RAM 12 are connected through the bus 6. The recording medium 10 stores program data of the operation system, game data made up of image data, audio data, and various types of program data, and the like. For example, the recording medium 10 is a ROM (Read Only Memory) cassette, an optical disk, a flexible disk, or the like. The program data of the operating system, the game data, and the like are stored in this recording medium 10. Note that a card memory is also included in the category of the recording medium 10. The card memory is mainly used for storing various game parameters at the point of interruption of the game. The RAM 12 is used for temporarily storing various types of data read out of the recording medium 10, and for temporarily recording the processing results of the control unit 1. The RAM 12 stores address data as well as various types of data. Note that the address data indicates the memory location of various types of data. The RAM 12 is allowed to specify an arbitrary address and read/write data from/onto the address.

The image display unit 3 is provided for mainly outputting various types of image data as an image. For example, the various types of image data include the image data written onto the RAM 12 by the image processor 9 and the image data read out of the recording medium 10. For example, the image display unit 3 is made up of a television monitor 20, an interface circuit 21, a D/A converter (Digital-to-Analog converter) 22. The D/A converter 22 is connected to the television monitor 20, and the interface circuit 21 is connected to the D/A converter 22. In addition, the bus 6 is connected to the interface circuit 21. Here, the image data is provided to the D/A converter 22 through the interface circuit 21, and is converted into an analog image signal in the D/A converter 22. Then, the analog image signal is outputted to the television monitor 20 as an image.

Here, the image data includes polygon data, texture data, and the like. The polygon data is the coordinate data of vertices forming a polygon. The texture data is used for setting texture with respect to the polygon. The texture data is made up of texture specifying data and texture color data. The texture specifying data is used for associating the polygon and the texture, and the texture color data is used for specifying the texture color. Here, the polygon data and the texture data are associated with polygon address data and texture address data, respectively. The polygon address data and the texture address data include storage locations of the polygon data and the texture data, respectively. As to the image data of this type, the signal processor 8 performs coordinate conversion and perspective projection conversion with respect to the polygon data in the three-dimensional space (i.e., the three-dimensional polygon data) specified by the polygon address data based on the displacement data and the rotation amount data of the screen itself (i.e., point of sight). Accordingly, the polygon data is converted into the polygon data in the two-dimensional space (i.e., the two-dimensional polygon data). Then, a polygon outline is constituted with a plurality of two-dimensional polygon data, and texture data specified by the texture address data is written onto the internal area of the polygon. Thus, it is possible to express a variety of objects (i.e., characters) made by applying texture to each polygon.

The audio output unit 4 is provided mainly for outputting the audio data read out of the recording medium 10 as audio. For example, the audio output unit 4 is made up of a speaker 13, an amplifier circuit 14, a D/A converter 15, and an interface circuit 16. The amplifier circuit 14 is connected to the speaker 13. The D/A converter 15 is connected to the amplifier circuit 14. The interface circuit 16 is connected to the D/A converter 15. In addition, the bus 6 is connected to the interface circuit 16. Here, the audio data is provided to the D/A converter 15 through the interface circuit 16 and is converted into an analog audio signal. The analog audio signal is amplified by the amplifier circuit 14, and is outputted from the speaker 13 as audio. For example, ADPCM (Adaptive Differential Pulse Code Modulation) data, PCM (Pulse Code Modulation) data, and the like are included in the category of the audio data. In the case of the ADPCM data, it is possible to output the audio from the speaker 13 with almost the same type of the above-mentioned processing method. In the case of the PCM data, if the PCM data is converted into the ADPCM data in the RAM 12, it is possible to output the audio from the speaker 13 with almost the same type of the above-mentioned processing method.

The operation input unit 5 is mainly made up of a controller 17, an operation information interface circuit 18, and an interface circuit 19. The operation information interface circuit 18 is connected to the controller 17, and the interface circuit 19 is connected to the operation information interface circuit 18. In addition, the bus 6 is connected to the interface circuit 19.

The controller 17 is an operation unit used by the video game player for the purpose of inputting various operation commands, and transmits operation signals to the CPU 7 according to the video game player's operation. The controller 17 is provided with a first button 17a, a second button 17b, a third button 17c, a fourth button 17d, an up key 17U, a down key 17D, a left key 17L, a right key 17R, a L1 button 17L1, a L2 button 17L2, a R1 button 17R1, a R2 button 17R2, a start button 17e, a select button 17f, a left stick 17SL, and a right stick 17SR.

For example, the up key 17U, the down key 17D, the left key 17L, and the right key 17R are used for providing the CPU 7 with a command to cause the characters and a cursor to move up, down, left, and right on the screen of the television monitor 20.

For example, the start button 17e is used for commanding the CPU 7 to load the game program from the recording medium 10 and for suspending the running game program.

For example, the select button 17f is used for commanding the CPU 7 to execute various selections with respect to the game program loaded from the recording medium 10.

The left stick 17SL and the right stick 17SR are stick-shaped controllers with approximately the same configuration as a so-called joystick. This stick-shaped controller includes an upright stick. The stick is be allowed to lean from the upright position to 360-degree directions including front, back, left, and right directions, centering around the fulcrum. The left and right sticks 17SL and 17SR respectively transmit their positional information as an operation signal to the CPU 7 through the operation information interface circuit 18 and the interface circuit 19. Here, their upright positions are defined as the origin of the x-y coordinate, and their positions are accordingly expressed with values in the x-y coordinate. When the left and right sticks 17SL and 17SR are leaned, their positions are determined depending on their leaned directions and angles.

Various functions are allocated to the first button 17a, the second button 17b, the third button 17c, the fourth button 17d, the L1 button 17L1, the L2 button 17L2, the R1 button 17R1, and the R2 button 17R2 depending on the game program to be loaded from the recording medium 10.

Here, excluding the left and right sticks 17SL and 17SR, the buttons and the keys provided in the controller 17 functions as ON/OFF switches. Specifically, they are switched to an on-state when pressed from the neutral position by the external pressure. On the other hand, when the pressure is released, they return to the neutral positions and are switched to an off-state.

The general operations of the above-configured home video game device will be hereinafter explained. When a power switch (not illustrated in the figure) is turned on and the game system 1 is powered on, the CPU 7 reads out image data, audio data, and program data from the recording medium 10 based on the operating system stored in the recording medium 10. All or part of the read-out data including the image data, the audio data, and the program data are stored in the RAM 12. Then, the CPU 7 issues commands for data stored in the RAM 12 (e.g., the image data and the audio data) based on the program data stored in the RAM 12.

In a case of the image data, the signal processor 8 firstly performs a variety of computations (e.g., positional computation and light source computation for a character in the three-dimensional space) based on the command from the CPU 7. Next, the image processor 9 executes a variety of processing (e.g., processing for writing the image data (to be rendered) onto the RAM 12) based on the computation results by the signal processor 8. Then, the image data written onto the RAM 12 is provided to the D/A converter 22 through the interface circuit 21. Here, the image data is converted into an analog image signal by the D/A converter 22. The image data is subsequently provided to the television monitor 20 and is displayed as an image.

In a case of the audio data, the signal processor 8 firstly executes processing to generate and process audio data based on the command from the CPU 7. Here, a variety of processing (e.g., pitch conversion, noise addition, envelope setting, level setting, and reverb addition) are executed for the audio data. Next, the audio data is outputted from the signal processor 8, and is provided to the D/A converter 15 through the interface circuit 16. Here, the audio data is converted into an analog audio signal. Then, the audio data is outputted as the audio from the speaker 13 through the amplifier circuit 14.

### Summary of Various Processing in Game Device

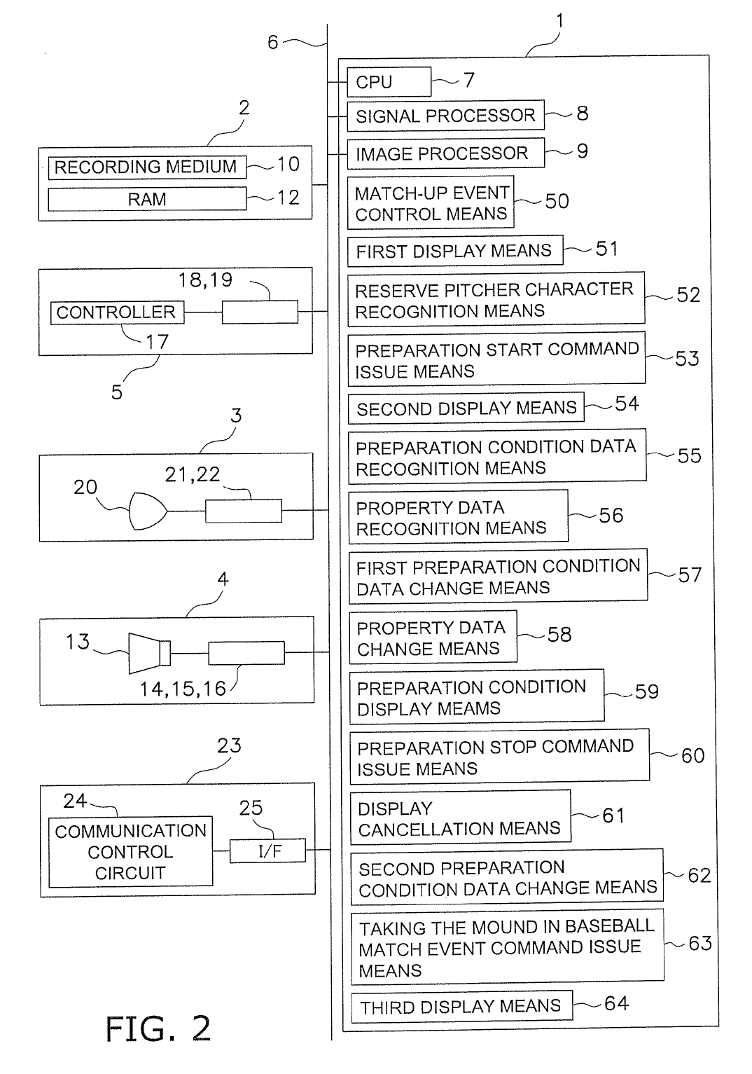

For example, a baseball video game is executed in the present game console. The present game console is capable of displaying a player character on the television monitor 20. FIG. 2 is a functional block diagram for explaining functions playing major roles in the present invention.

Match-up event control means 50 has a function of causing the CPU 7 to execute processing for controlling a match-up event in a video game.

In the means, the CPU 7 executes processing for controlling a match-up event in a baseball video game. For example, processing for controlling a match-up event includes processing for displaying a variety of basis images (e.g., stadium image), processing for a variety of actions in the match-up event, and processing for managing the match-up event. Also, the processing for variety of actions includes processing of motion pictures of a variety of player characters, processing of computing ball orbit in the game space, processing of determining if a bat hit a ball in the game space, processing of determining if a fielder character caught the ball, and the like.

Here, data and computational expression to be used in processing for controlling a match-up event are preliminarily determined. When a game program is loaded, they are provided from the recording medium 10 to the RAM 12, and are stored in the RAM 12.

First display means 51 has a function of displaying a pitcher character in a match-up event on a baseball match screen with pitcher character's image data.

In the means, a pitcher character to play on the mound (or pitching mound) in a match-up event (baseball match event) is displayed on a baseball match screen with pitcher character's image data. For example, in the means, the CPU 7 recognizes the pitcher character's image data stored in the RAM 12. Then, the image data is provided to the television monitor 20 through the image processing circuit 14 based on an instruction by the CPU 7. Accordingly, a pitcher character to play on the mound in the baseball match event is displayed on a predetermined position on the television monitor 20 based on pitcher character's position coordinate data. Here, the pitcher character to play on the mound in a baseball match event is displayed on the baseball match screen of the television monitor 20.

Also, the pitcher character's position coordinate data is preliminarily determined in the game program. When the game program is loaded, the pitcher character's coordinate data is provided from the recording medium 10 to the RAM 12, and is stored in the RAM 12.

Reserve pitcher character recognition means 52 has a function of causing the CPU 7 to recognize a reserve pitcher character standing by for going to the mound with pitcher character's identification data.

In the means, the CPU 7 recognizes a reserve pitcher character standing by for replacement in a baseball match event (i.e., reserve pitcher character) with pitcher character's identification data. For example, in the means, the CPU 7 is caused to recognize identification data for identifying a reserve pitcher character, and thereby the CPU 7 recognizes data of the reserve pitcher character (e.g., image data) corresponding to the identification data.

Correspondence relation between the identification data for identifying a reserve pitcher character and data of the reserve pitcher character is preliminarily determined in the game program. When the game program is loaded, the correspondence relation is provided from the recording medium 10 to the RAM 12, and is stored in the RAM 12. For example, the correspondence relation is determined in a correspondence table.

Preparation start command issue means 53 has a function of causing the CPU 7 to issue a preparation start command for causing a reserve pitcher character to start preparation for replacement in a baseball match event.

In the means, the CPU 7 issues a preparation start command for causing a reserve pitcher character to start preparation for replacement in a baseball match event. For example, in the means, when the controller 17 is operated for causing a reserve pitcher character to start preparation of pitching (i.e., warm-up) at the bullpen, the CPU 7 issues a command for causing a reserve pitcher character to start preparation of pitching (i.e., a preparation start command). Here, the CPU 7 is caused to recognize identification data of a reserve pitcher character selected by the instruction through the controller 17, and thereby a reserve pitcher character to go to the bullpen is specified. Then, the CPU 7 issues a preparation start command with respect to the specified reserve pitcher character.

In the above-mentioned example, the CPU 7 issues the preparation start command through the game player's operation of the controller 17. However, the CPU 7 may issue the preparation start command based on an artificial intelligence (AI) program. When an opponent of a game player is a computer, the AI program controls a variety of commands with respect to baseball player characters of an opponent baseball team.

Second display means 54 has a function of displaying a reserve pitcher character warming up for replacement in a baseball match on a bullpen screen with the pitcher character's image data when the CPU 7 issues the preparation start command.

In the means, when the CPU 7 issues the preparation start command, a reserve pitcher character warming up for replacement in a baseball match is displayed on a bullpen screen with the pitcher character's image data. For example, in the means, when the CPU 7 issues the preparation start command, the CPU 7 recognizes the pitcher character's image data of a reserve pitcher character warming up at the bullpen stored in the RAM 12. Then, the image data is provided to the television monitor 20 through the image processing circuit 14 based on an instruction by the CPU 7. Accordingly, a reserve pitcher character warming up at the bullpen is displayed on a predetermined position on the television monitor 20 based on the pitcher character's position coordinate data. Here, a pitcher character to play on the mound in a baseball match event is displayed on the bullpen screen of the television monitor 20.

Here, the pitcher character's position coordinate data is preliminarily determined in the game program. When the game program is loaded, the pitcher character's position coordinate data is provided from the recording medium 10 to the RAM 12, and is stored in the RAM 12.

Preparation condition data recognition means 55 has a function of causing the CPU 7 to recognize a preparation condition of a reserve pitcher character warming up for replacement in a baseball match event with pitcher character's preparation condition data when the CPU 7 issues the preparation start command.

In the means, when the CPU 7 issues the preparation start command, the CPU 7 recognizes a preparation condition of a reserve pitcher character warming up for replacement in a baseball match event with pitcher character's warm-up condition data. For example, in the means, when the CPU 7 issues the preparation start command, the CPU 7 recognizes preparation condition data for indicating a preparation condition of a reserve pitcher character warming up at the bullpen.

Property data recognition means 56 has a function of causing the CPU 7 to recognize a property of a reserve pitcher character warming up for replacement in a baseball match event with pitcher character's property data when the CPU 7 issues the preparation start command.

In the means, when the CPU 7 issues the preparation start command, the CPU 7 recognizes a property of a reserve pitcher character warming up for replacement in a baseball match event with pitcher character's property data. For example, in the means, when the CPU 7 issues the preparation start command, the CPU 7 recognizes toughness data for indicating a toughness property of a reserve pitcher character warming up at the bullpen.

In the above-mentioned example, the pitcher character's property data is the toughness data. However, it may be other type of data.

First preparation condition data change means 57 has a function of causing the CPU 7 to execute processing of changing the preparation condition data of a reserve pitcher character warming up for replacement in a baseball match event in conjunction with a motion of a pitcher character currently on the mound.

In the means, the CPU 7 determines if a motion of a pitcher character currently on the mound is a pitching motion with respect to a batter character or a pickoff motion with respect to a fielder character. When the motion of the pitcher character currently on the mound is a pitching motion, the CPU 7 executes processing of changing the preparation condition data of a reserve pitcher character warming up for participating in a baseball match event in conjunction with the pitching motion of the pitcher character currently on the mound. For example, this case assumes that a reserve pitcher character warming up for participating in a baseball match event has performed a pitching motion at the same frequency as a pitching motion of the pitcher character currently on the mound with respect to a batter character. Based on this, the control unit executes processing of changing the preparation condition data of a reserve pitcher character warming up for participating in a baseball match event. Also, when the motion of the pitcher character currently on the mound is a pickoff motion, the CPU 7 executes processing of maintaining the preparation condition data of a reserve pitcher character warming up for participating in a baseball match event.

For example, in the means, the CPU 7 determines if the motion of the pitcher character currently on the mound is a pitching motion with respect to a batter character or a pickoff motion with respect to a fielder character. In other words, the CPU 7 determines if a command for the pitcher character currently on the mound is a pitching command with respect to a batter character or a pickoff command with respect to a fielder character. Then, when the command for the pitcher character currently on the mound is a pitching command with respect to a batter character, the preparation condition data of a reserve pitcher character warming up at the bullpen is changed to be larger in proportion to the number of pitches released by the pitcher character currently on the mound. On the other hand, when the motion of the pitcher character currently on the mound is a pickoff motion, the CPU 7 maintains the preparation condition data of the reserve pitcher character warming up at the bullpen.

Property data change means 58 has a function of causing the CPU 7 to execute processing of changing property data of a reserve pitcher character warming up for replacement in a baseball match event in conjunction with a motion of a reserve pitcher character warming up for replacement in a baseball match event when the pitcher character's preparation condition data reaches a predetermined value.

In the means, when the pitcher character's preparation condition data reaches a predetermined value, the CPU 7 executes processing of changing the property data of the reserve pitcher character warming up for replacement in a baseball match event in conjunction with a motion of the reserve pitcher character warming up for replacement in a baseball match event.

For example, in the means, when the pitcher character's preparation condition data reaches a predetermined value, the toughness data of the reserve pitcher character warming up at the bullpen is changed to be smaller in proportion to the number of pitches released by the reserve pitcher character warming up at the bullpen. Accordingly, it is possible to evaluate an impact of excessive warm-up of a pitcher character in the baseball video game.

Preparation condition display means 59 has a function of displaying a preparation condition of a reserve pitcher character warming up for replacement in a baseball match event on at least either of the baseball match screen and the bullpen screen based on the pitcher character's preparation condition data with preparation condition's image data.

In the means, based on the pitcher character's preparation condition data, a preparation condition of a reserve pitcher character warming up for replacement in a baseball match event is displayed on at least either of the baseball match screen and the bullpen screen with preparation condition's image data. For example, in the means, a warm-up gauge for indicating a preparation condition of the reserve pitcher character warming up at the bullpen is displayed on at least either of the baseball match screen and the bullpen screen with gauge's image data. Here, a scale of the warm-up gauge is set based on the pitcher character's preparation condition data.

Preparation pause command issue means 60 has a function of causing the CPU 7 to issue a preparation pause command for causing a pitcher character to pause warming up for replacement in a baseball match event.

In the means, the CPU 7 issues a preparation pause command for causing a pitcher character to pause warming up for replacement in a baseball match event. For example, in the means, when the controller 17 is operated for getting a reserve pitcher character warming up at the bullpen back to a bench, the CPU 7 issues a command for getting the reserve pitcher character warming up at the bullpen back to the bench (i.e., a preparation pause command). Here, the CPU 7 is caused to recognize the identification data of a reserve pitcher character warming up at the bullpen selected through the operation of the controller 17, and thereby a pitcher character to get back from the bullpen to the bench is specified. Then, the CPU 7 issues a preparation pause command for the specified reserve pitcher character warming up at the bullpen.

Display cancellation means 61 has a function of causing the CPU 7 to issue a character clear command for clearing a reserve pitcher character warming up replacement in a baseball match event from the bullpen screen when the CPU 7 issues the preparation pause command.

In the means, when the CPU 7 issues the preparation pause command, the CPU 7 issues a character clear command for clearing a reserve pitcher character warming up for replacement in a baseball match event from the bullpen screen. For example, in the means, when the CPU 7 issues the preparation pause command, the CPU 7 issues a character clear command for clearing the reserve pitcher character warming up at the bullpen from the bullpen screen. Accordingly, the reserve pitcher character warming up at the bullpen is cleared from the bullpen screen.

Second preparation condition data change means 62 has a function of causing the CPU 7 to execute processing of changing the preparation condition data of a reserve pitcher character warming up for replacement in a baseball match event in conjunction with a motion of a pitcher character currently on the mound after the CPU 7 issues the preparation pause command.

In the means, after the CPU 7 issues the preparation pause command, the CPU 7 executes processing of changing the preparation condition data of a reserve pitcher character warming up for replacement in a baseball match event in conjunction with a motion of the pitcher character currently on the mound. For example, in the means, after the CPU 7 issues the preparation pause command, the preparation condition data of a reserve pitcher character warming up at the bullpen is changed to be smaller in proportion to the number of pitches released by the pitcher character currently on the mound. Accordingly, it is possible to evaluate impact of taking a break from warm-up on a pitcher character in the baseball video game.

Taking the mound in baseball match event command issue means 63 has a function of causing the CPU 7 to issue “a taking the mound in baseball match event command” for causing a reserve pitcher character warming up for replacement in a baseball match event to play on the mound.

In the means, the CPU 7 issues a taking the mound in baseball match event command for causing a reserve pitcher character warming up for replacement in a baseball match event to play on the mound. For example, in the means, when the controller 17 is operated for causing a reserve pitcher character warming up at the bullpen to play on the mound in a baseball match event, the CPU 7 issues a command for causing the reserve pitcher character warming up at the bullpen to play on the mound (i.e., a taking the mound in baseball match event command). Here, the CPU 7 is caused to recognize the identification data of a reserve pitcher character warming up at the bullpen selected by the instruction through the controller 17, and thereby a pitcher character to play on the mound in a baseball match event is specified. Then, the CPU 7 issues the taking the mound in baseball match event command with respect to the specified reserve pitcher character warming up at the bullpen.

Third display means 64 has a function of displaying a reserve pitcher character warming up for replacement in a baseball match event on the baseball match screen with the pitcher character's image data when the CPU 7 issues the taking the mound in baseball match event command.

In the means, when the CPU 7 issues the taking the mound in baseball match event command, a reserve pitcher character warming up for replacement in a baseball match event is displayed on the baseball match screen with the pitcher character's image data. For example, in the means, when the CPU 7 issues the taking the mound in baseball match event command, a reserve pitcher character warming up at the bullpen is displayed on the baseball match screen with the pitcher character's image data.

### Summary of Warm-Up System in Baseball Video Game

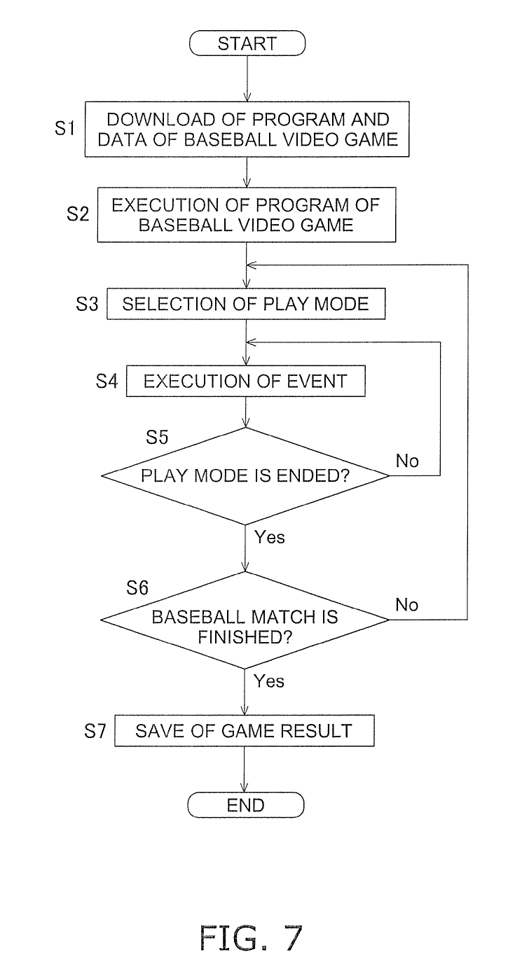

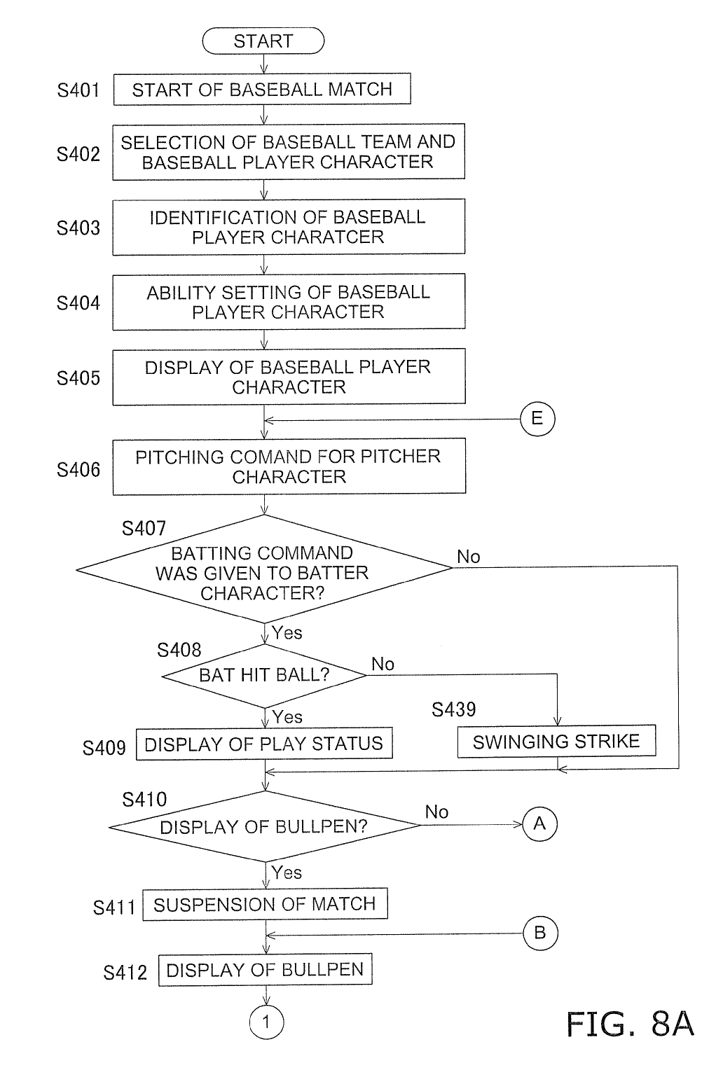

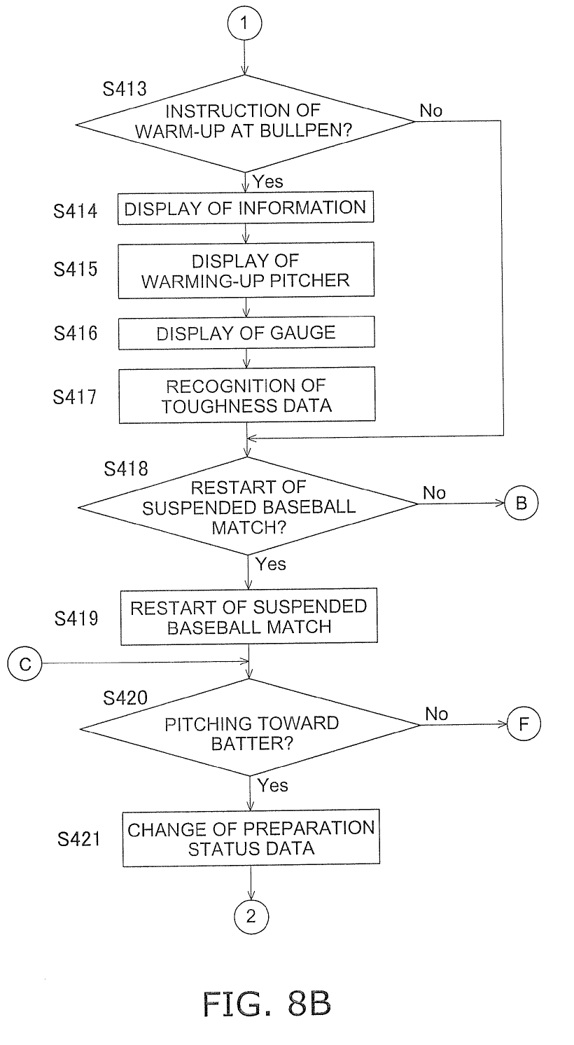

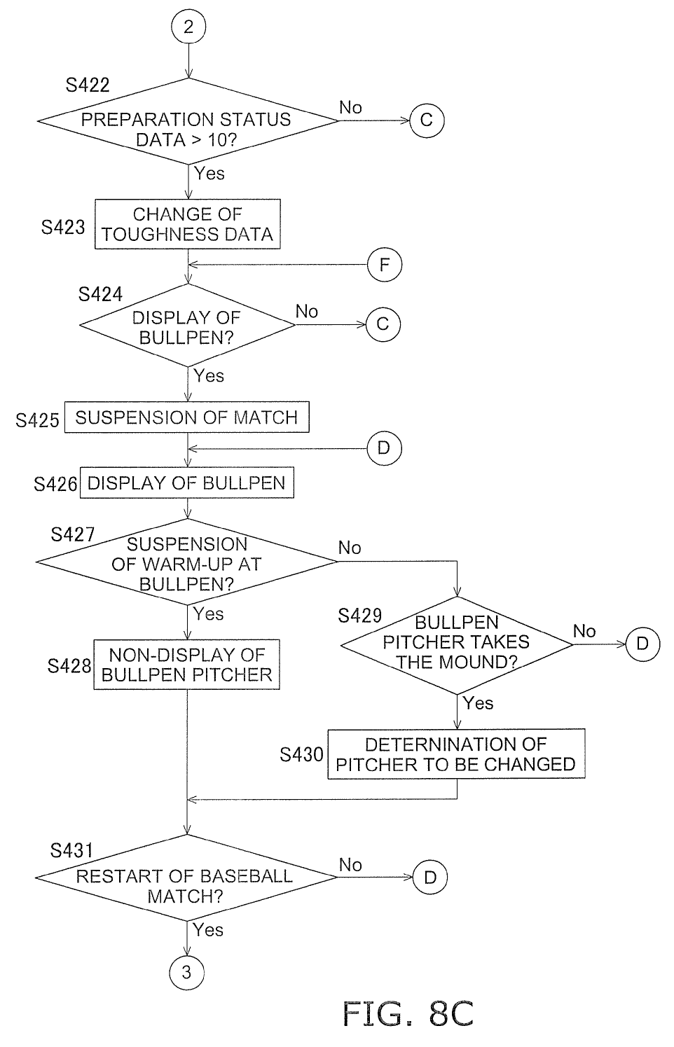

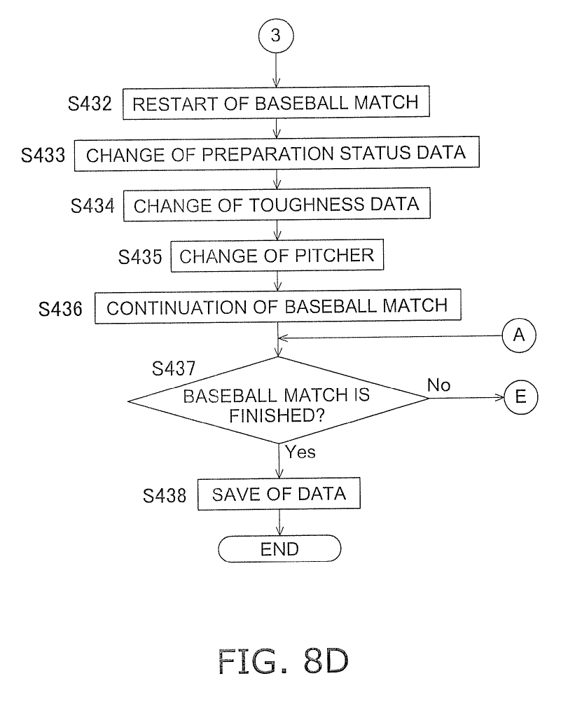

Next, a warm-up system in the baseball video game will be specifically explained. Also, flowcharts illustrated in FIGS. 7 and 8 will be herein simultaneously explained. FIG. 7 illustrates a flowchart for explaining summary of the entire baseball video game. FIG. 8 is a flowchart for explaining the warm-up system.

First, when the game console is powered on and started, a baseball game program is loaded from the recording medium 10 to the RAM 12, and is stored in the RAM 12. Here, a variety of basic game data necessary for executing the baseball video game are simultaneously loaded from the recording medium 10 to the RAM 12, and are stored in the RAM 12 (Step S1 of FIG. 7).

For example, the basic game data includes data of a variety of images for the three-dimensional game space. For example, the data of a variety of images include stadium's image data, baseball player character's image data, and various object's image data. Then, the CPU 7 recognizes the data of a variety of images. Also, the basic game data includes position coordinate data for arranging the data of a variety of images in the three-dimensional game space. Furthermore, the basic game data includes data to be used for the warm-up system.

Next, the CPU 7 executes the baseball game program stored in the RAM 12 based on the basic game data (Step S2 of FIG. 7). Then, a starting screen of the baseball video game is displayed on the television monitor 20. Accordingly, a variety of setting screens are displayed on the television monitor 20 for executing the baseball video game. For example, a mode selection screen (not illustrated in the figure) is herein displayed on the television monitor 20 for selecting a play mode of the baseball video game. When a game player operates the controller 17 while the mode selection screen is being displayed, a play mode is accordingly determined (Step S3 of FIG. 7). For example, the play mode includes a match-up mode, a pennant-race mode, a developing mode, and a virtual growth mode. In the match-up mode, a game player selects one of 12 baseball teams, and enjoys a match-up game. Note that the number of baseball teams may be set to 30 when the baseball video game is created based on the major league baseball. In the pennant-race mode, a game player selects one of 12 baseball teams and plays matches in the pennant race. In the developing mode, a game player develops baseball player characters as a manager of his/her selected team. In the virtual growth mode, a game player virtually experiences the baseball video game from the point of a baseball player character.

Next, the CPU 7 executes a variety of events in the play mode selected through the mode selection screen (Step S4 of FIG. 7). For example, the variety of events to be herein executed include an event automatically controlled by the CPU 7 based on the AI program and an event manually controlled by a game player based on an input signal from the controller 17. Also, control of a baseball player character includes an automatic control for automatically giving a baseball player character a command based on the AI program, a manual control for directly giving a baseball player character a command based on an input signal from the controller 17, and the like. Thus, the present baseball video game controls an event and give a baseball player character a command in accordance with an instruction from the controller 17 and the AI program.

Next, the CPU 7 determines if the selected play mode was finished (Step S5). Specifically, the CPU 7 determines if a command for indicating finish of the play mode was issued. Then, when the CPU 7 determined that the command for indicating finish of the play mode was issued (Yes in Step S5 of FIG. 7), the CPU 7 executes processing of storing game continuation data in the RAM 12. When the game continuation data was stored in the RAM 12, a selection screen is displayed on the television monitor 20 for making a game player determine if the game player stops playing the baseball video game (Step S6 of FIG. 7). When the game player selected an item for terminating the baseball video game on the selection screen through an operation of the controller 17 (Yes in Step S6 of FIG. 7), the CPU 7 executes processing for terminating the baseball video game (Step S7 of FIG. 7). On the other hand, when the game player selected an item for continuing the baseball video game on the selection screen through an operation of the controller 17 (No in Step S6 of FIG. 7), the mode selection screen in Step S3 is redisplayed on the television monitor 20.

Unless the CPU 7 determines that the command for terminating the play mode was issued (No in Step S5 of FIG. 7), the CPU 7 executes a variety of events in the play mode selected on the mode selection screen (Step S4 of FIG. 7).

Next, the warm-up system for setting an ability of a baseball player character will be hereinafter explained in detail.

The following is an example of the warm-up system that functions in the match-up mode. In the following example, the match-up mode is selected on the mode selection screen, and the warm-up system functions while a baseball match event is performed in the match-up mode. In the match-up mode, a team A is controlled by the AI program and a team B is controlled by a game player. Also, the team A is set to bat first while the team B is set to take the field first. Especially, in the following example, the warm-up system functions when a game player gives a pitcher character of the team B a command.

When a game player selects the match-up mode on the mode selection screen, the CPU 7 executes a baseball game event (Step S401 of FIG. 8A). Then, in Step S402 of FIG. 8A, teams (i.e., teams A and B) are selected through a team selection screen (not illustrated in the figure). In addition, baseball player characters of the teams A and B are selected through a player selection screen (not illustrated in the figure).

Accordingly, the CPU 7 recognizes the identification data for identifying the starting lineup of the teams A and B (Step S403 of FIG. 8A). For example, the CPU 7 recognizes the identification data for each of the baseball player characters in the starting lineup of the teams A and B, and the identification data for each of reserve baseball player characters of the teams A and B. Here, the CPU 7 recognizes the identification data of a starting pitcher character 70 and a reserve pitcher character 71 relating to the warm-up system.

Accordingly, the CPU 7 executes basic settings with respect to the data for each baseball player character. For example, a setting of an ability property of each baseball player character is included in the herein-executed basic settings. Here, the CPU 7 is caused to recognize ability property data NT (ID, n) of a baseball player character corresponding to an identification data ID of a baseball player character and a variety of ability properties n of a baseball player character, and thereby the ability property of each baseball player character is set (Step S404 of FIG. 8A).

For example, the herein-used ability properties n includes ball-trajectory (n=1), power (n=2), base-running skill (n=3), throwing ability (n=4), fielding ability (n=5), ball-velocity (n=6), ball-control (n=7), and toughness (n=8). The ability property data NT (ID, n) corresponding to each of the plurality of ability properties n is stored in the RAM 12. Thus, the CPU 7 is caused to recognize the ability property data NT (ID, n) stored in the RAM 12, and thereby the ability property of each of the baseball player characters is set. Here, the CPU 7 recognizes each of predetermined ability property data stored in the RAM 12 (i.e., the initial data).

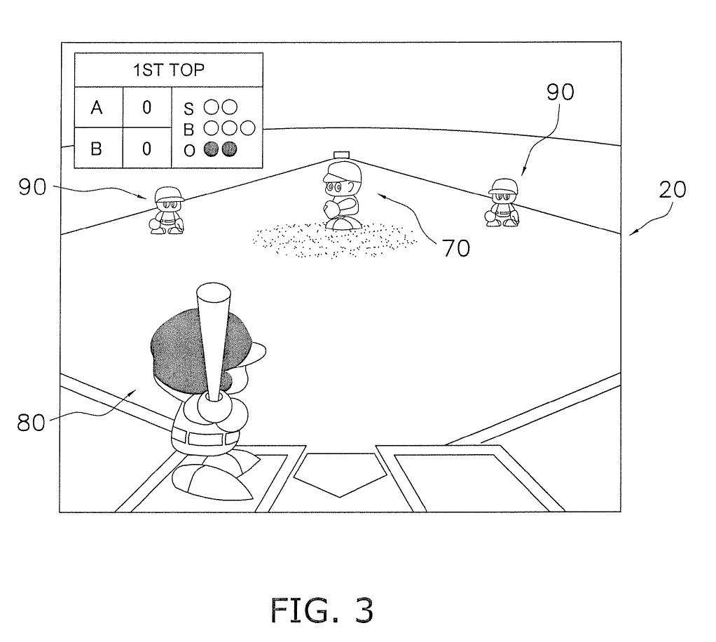

As described above, when the CPU 7 recognizes the identification data ID of each baseball player character, the CPU 7 recognizes data of a baseball player character corresponding to each identification data (e.g., image data). Accordingly, a pitcher character 70, a batter character 80, and a fielder character 90 are displayed on the television monitor 20 with the image data. As illustrated in FIG. 3, the pitcher character 70, the batter character 80, and the fielder character 90 are displayed on a baseball match screen 75 of the television monitor 20 (Step S405 of FIG. 8A). In FIG. 3, the characters are seen from a catcher character.

When a game player repeatedly operates a predetermined button of the controller 17 in this state, a pitching command is given to the pitcher character 70 (Step S406 of FIG. 8A). For example, the CPU 7 issues a command for causing the pitcher character 70 to start a pitching motion, a command for determining a pitching trajectory, and a command for causing the pitcher character 70 to release a ball object. Accordingly, a series of pitching motion of the pitcher character 70 is displayed on the television monitor 20, and the ball object released by the pitcher character 70 is displayed on the television monitor 20.

Next, the CPU 7 determines if a command of batting was given to the batter character 80 based on the AI program (Step S407 of FIG. 8A). The command of batting with respect to the batter character 80 includes a command for moving a ball-hitting zone and a swing start command with respect to the batter character 80.

Next, when the CPU 7 determined that the command of batting was given to the batter character 80 based on the AI program (Yes in Step S407 of FIG. 8A), a series of swing motion of the batter character 80 is displayed on the television monitor 20. Then, when the swing start command is given to the batter character 80 based on the AI program (Yes in Step S407 of FIG. 8A), the CPU 7 determines if the ball object was hit by the batter character 80 (Step S408 of FIG. 8A). For example, the CPU 7 determines if the ball-hitting zone and the ball object were overlapped. Specifically, the CPU 7 determines if at least one coordinate data within the ball-hitting zone and at least one coordinate data within the ball object corresponded to each other.

Then, when it was determined by the CPU that the ball object was not hit by the batter character 80 (No in Step S408 of FIG. 8A), in other words, when the ball-hitting zone and the ball object were not overlapped, the CPU 7 executes processing of incrementing the strike count. This corresponds to a case that the batter character 80 swung a bat but missed the ball object (Step S439 of FIG. 8A).

On the other hand, when the CPU 7 determined that the ball object was hit by the batter character 80 (Yes in Step S408 of FIG. 8A), in other words, when the ball-hitting zone and the ball object were overlapped, the CPU 7 executes processing for computing an orbit and a drop position of the hit ball object based on the orbit equation. Then, depending on the result of the hit ball object, the CPU 7 executes processing of changing at least one of a flag for indicating on-base status of each base, score data for indicating score status, out count, and the like. Accordingly, the result of the hit ball object is reflected in the baseball match screen 75 (Step S409 of FIG. 8A).

Here, the orbit equation for computing an orbit and a drop position of the hit ball object is preliminarily determined in the game program. When the baseball game program is loaded, the orbit equation is stored in the RAM 12.

When the swing start command was not given to the batter character 80 based on the AI program (No in Step S407 of FIG. 8A), a swing motion of the batter character 80 is not displayed on the television monitor 20. This corresponds to a case that the batter character 80 did not swing a bat when the ball object was released. In this case, the CPU 7 executes processing of incrementing any one of the strike count, the ball count, and the out count. Then, the CPU 7 re-executes processing in Step S406 of FIG. 8A.

The above-mentioned match-up between the pitcher character 70 and the batter character 80 is consecutively performed by the alternate control of baseball player characters on the offensive position by a game player and the AI program. While the above-mentioned match-up is consecutively performed, the CPU 7 determines if a command for displaying a bullpen screen 76 was given (Step S410 of FIG. 8A). For example, when a game player is on the defensive position, the CPU 7 determines if a pause button (i.e., the start button 17e) of the controller 17 was pressed for displaying the bullpen screen 76. Then, when the pause button was pressed (Yes in Step S410 of FIG. 8A), the running baseball match event is suspended (Step S411 of FIG. 8A).

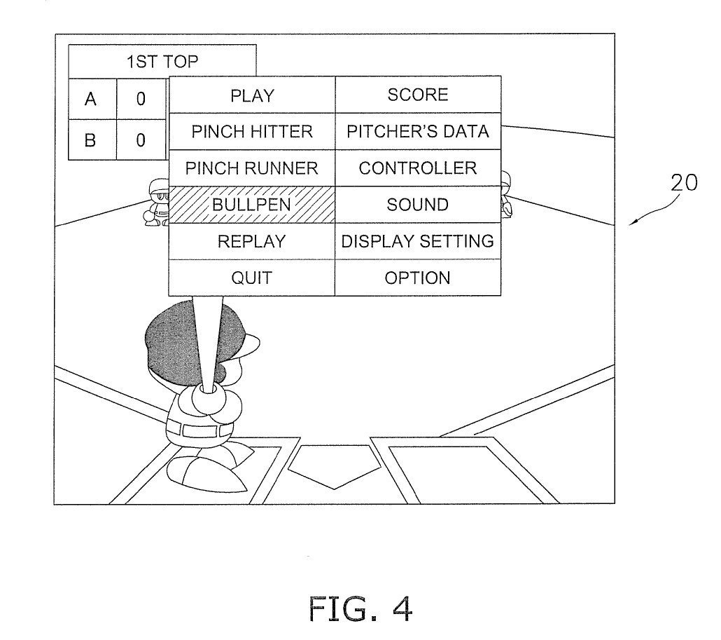

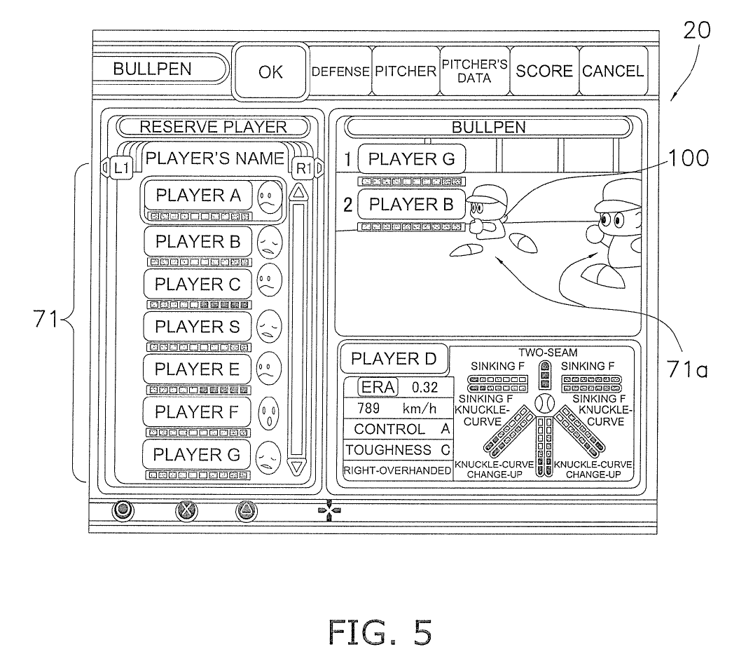

As illustrated in FIG. 4, a list of interrupt commands is displayed on the television monitor 20. Here, a game player is capable of giving the interrupt commands while a baseball match event is executed. When a bullpen item is selected from the list, the bullpen screen 76 is displayed on the television monitor 20 as illustrated in FIG. 5 (Step S412 of FIG. 8A).

A list of reserve pitcher characters 71, a pitcher character 71a warming up at the bullpen, and information of the reserve pitcher characters 71 are displayed on the bullpen screen 76. For example, the list of the reserve pitcher characters 71 is displayed on the left side of the bullpen screen 76. Also, the pitcher character 71a warming up at the bullpen is displayed on the upper right part of the bullpen screen 76. Furthermore, information of the reserve pitcher character 71 currently being selected from the list of the reserve pitcher characters 71 is displayed on the lower right part of the bullpen screen 76. Here, FIG. 5 illustrates a screenshot that a reserve pitcher character warming up at the bullpen has already been displayed.

In the bullpen screen 76, the CPU 7 determines if a command of warm-up at the bullpen was given to the reserve pitcher character 71 on the bench (Step S413 of FIG. 8B). For example, in the bullpen screen 76, the CPU 7 determines if a game player's desired pitcher character was selected from the list of the reserve pitcher characters 71 on the bench. Then, when the game player's desired pitcher character was selected from the list (Yes in Step S413 of FIG. 8B), information of the selected reserve pitcher character is displayed on the lower right part of the bullpen screen 76 (Step S414 of FIG. 8B). Next, when a confirmation button (i.e., the second button 17b) of the controller 17 was pressed in the state, the CPU 7 recognizes identification data IDh of the reserve pitcher character 71a selected through the controller 17. Accordingly, a pitcher character to go to the bullpen is specified.

Accordingly, the CPU 7 issues a command for causing the reserve pitcher character to warm-up at the bullpen (i.e., the preparation start command). Then, the CPU 7 recognizes the image data corresponding to the identification data of the reserve pitcher character selected through the controller 17. Accordingly, the pitcher character 71 a warming up at the bullpen is displayed on the upper right part of the bullpen screen 76 with the corresponding pitcher character's image data (Step S415 of FIG. 8B). Here, a game player is capable of selecting up to two pitcher characters from the list of the reserve pitcher characters on the bench.

Also, when the reserve pitcher character warming up at the bullpen was displayed on the upper right part of the bullpen screen 76, the CPU 7 recognizes preparation condition data JD for indicating a pitcher character's preparation condition. Here, when a reserve pitcher character warms-up at the bullpen for the first time, the CPU 7 recognizes the initial data (=“0”) of the preparation condition data stored in the RAM 12. Also, when a reserve pitcher character resumes warm-up at the bullpen, the CPU 7 recognizes the preparation condition data JD previously stored in the RAM 12 (i.e., the latest preparation condition data).

Thus, when the CPU 7 recognized the preparation condition data JD of the reserve pitcher character warming up at the bullpen, a warm-up gauge 100 for indicating a preparation condition of the reserve pitcher character warming up at the bullpen is displayed on the upper right part of the bullpen screen 76 with the gauge's image data (Step S416 of FIG. 8B).

Here, a scale of the warm-up gauge 100 is set based on the pitcher character's preparation condition data JD. For example, the pitcher character's preparation condition data JD is one of natal numbers between “0” to “20”. Also, the warm-up gauge 100 includes a 10-staged scale.

In the war-up gauge 100, the scale is highlighted depending on a value of the pitcher character's preparation condition data JD. For example, when the value of the pitcher character's preparation condition data JD is one of the numbers from “0” to “10”, the scale corresponding to the value of the pitcher character's preparation condition data JD is highlighted. Also, when the value of the pitcher character's preparation condition data JD is one of the numbers from “11” to “20”, the scale corresponding to the value “10” of the pitcher character's preparation condition data JD is highlighted. In other words, all the scales up to the tenth stage are highlighted.

Also, when the reserve pitcher character warming up at the bullpen is displayed on the upper right part of the bullpen screen 76, the CPU 7 recognizes ability property data NT (IDh, n) for indicating an ability property of the reserve pitcher character warming up at the bullpen (Step S417 of FIG. 8B). Here, the ability property data NT (IDh, n) to be recognized by the CPU 7 is stored in the RAM 12 when the baseball game program is loaded.

The following is an example of the ability property data NT (IDh, n) of the reserve pitcher character warming up at the bullpen. Specifically, the ability property data NT (IDh, n) is the toughness data NT (IDh, 8). The toughness data NT (IDh, 8) corresponds to the toughness property. However, it should be understood that the ability property data NT (IDh, n) is not necessarily limited to the toughness data NT (IDh, 8) and may be other type of data. For example, it may be throwing ability data NT (IDh, 4), ball-velocity data NT (IDh, 6), or ball-control data NT (IDh, 7).

Next, the CPU 7 determines if a command for resuming a baseball match event was given (Step S418 of FIG. 8B). For example, the CPU 7 determines if an input button for resuming a baseball match event (e.g., the third button 17c of the controller 17) was pressed. Then, when the third button 17c was pressed (Yes in Step S418 of FIG. 8B), the CPU 7 issues a command for switching the screen displayed on the television monitor 20 from the bullpen screen 76 to the baseball match screen 75. Accordingly, the CPU 7 resumes the suspended control for a baseball match event, and the baseball match event screen 75 is displayed on the television monitor 20. Then, the CPU 7 re-executes match-up processing between a pitcher character and a batter character (Step S419 of FIG. 8B).

Thus, when the match-up processing between a pitcher character and a batter character was re-executed after a reserve pitcher character had been instructed to warm-up at the bullpen, the CPU 7 determines if a command for a pitcher character currently on the mound is a pitching command with respect to a batter character or a pickoff command with respect to a fielder character on each base (Step S420 of FIG. 8B).

Here, the CPU 7 determines if the command for a pitcher character currently on the mound is a pitching command or a pickoff command based on an input signal from the controller 17. Specifically, the CPU 7 determines if an input signal from the controller 17 is an input signal to be generated when a pitching command button is pressed or an input signal to be generated when a pickoff command button is pressed.

Here, when the suspended baseball match event was resumed, the CPU 7 executes processing of computing the number of balls released by a pitcher character currently on the mound with respect to a batter character after a reserve pitcher character is instructed to warm-up at the bullpen.

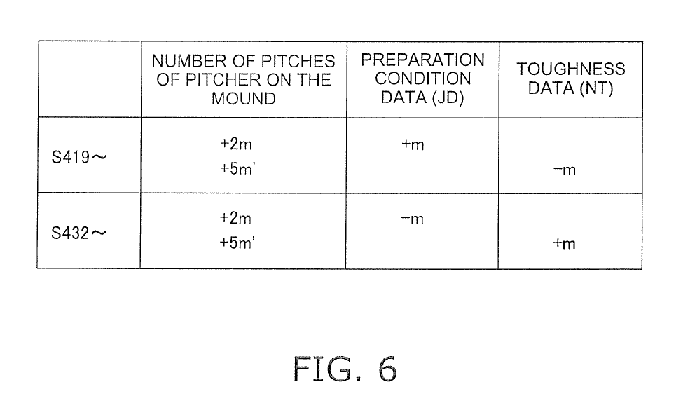

Then, when an input signal is generated from the controller 17 when the pitching command button is pressed, it is determined by the CPU that a command for a pitcher character currently on the mound is a pitching command (Yes in Step S420 of FIG. 8B). Then, the preparation condition data JD of a reserve pitcher character warming up at the bullpen is changed to be larger in proportion to the number of pitches released by a pitcher character currently on the mound (Step S421 of FIG. 8B). Specifically, as illustrated in FIG. 6, as the number of pitches released by a pitcher character currently on the mound is increased by two, the preparation condition data JD of a reserve pitcher character warming up at the bullpen is increased by one.

On the other hand, when an input signal is generated from the controller 17 when the pickoff command button is pressed, the CPU 7 determines that the command for a pitcher character currently on the mound is a pickoff command (No in Step S420 of FIG. 8B). Accordingly, the CPU 7 does not execute processing for changing the preparation condition data JD of a reserve pitcher character warming up at the bullpen. In other words, the CPU 7 does not execute access to the preparation condition data JD of a reserve pitcher character warming up at the bullpen in this case. Here, the CPU 7 may execute processing of adding “0 (zero)” to the preparation condition data JD of a reserve pitcher character warming up at the bullpen as another example case that the CPU 7 does not execute processing of changing the preparation condition data JD of a reserve pitcher character.

Then, the CPU 7 determines if the pitcher character's preparation condition data JD reached a predetermined value such as “10” (Step S422 of FIG. 8C). When the pitcher character's preparation condition data JD reached a predetermined value (JD≧10, Yes in Step S422 of FIG. 8C), the toughness data NT (IDh, 8) of a reserve pitcher character warming up at the bullpen is changed to be smaller in proportion to the number of pitches released by a pitcher character currently on the mound (Step S423 of FIG. 8C). Specifically, as illustrated in FIG. 6, as the number of pitchers released by a pitcher character currently on the mound is increased by 5, the toughness data NT (IDh, 8) of a reserve pitcher character warming up at the bullpen is decreased by one. Thus, it is possible to evaluate impact of excessive warm-up of a pitcher character in the baseball video game.

On the other hand, when the pitcher character's preparation condition data JD has not reached a predetermined value (e.g., “10”), in other words, when the pitcher character's preparation condition data JD is less than a predetermined value (JD<10, No in Step S422 of FIG. 8C), the CPU 7 re-executes processing in Step S420 of FIG. 8B.

Also, when the match-up processing between a pitcher character and a batter character has been re-executed after a reserve character was instructed to warm-up at the bullpen, the CPU 7 determines if a command for displaying the bullpen screen 76 was similarly given as Step S410 (Step S424 of FIG. 8C). For example, when a game player is on a defensive position, the CPU 7 determines if the pause button (i.e., the start button 17e) of the controller 17 was pressed for displaying the bullpen screen 76. When the pause button was pressed (Yes in Step S424 of FIG. 8C), a currently executed baseball match event is suspended again (Step S425 of FIG. 8C).

Accordingly, as described above, the list of interrupt commands available during execution of a baseball match event is displayed on the television monitor 20 (see FIG. 4). When a bullpen item is selected from the list, the bullpen screen 76 is re-displayed on the television monitor 20 as illustrated in FIG. 5 (Step S426 of FIG. 8C).

Here, the CPU 7 determines if a command for getting a reserve pitcher character warming up at the bullpen back to the bench (i.e., the preparation pause command) was given (Step S427 of FIG. 8C). For example, the CPU 7 determines if the third button 17c of the controller 17 was pressed while a pitcher name item corresponding to a warming-up pitcher character displayed on the upper right part of the bullpen screen 76 was being selected. When the third button 17c was pressed while the pitcher name item was being selected (Yes in Step S427 of FIG. 8C), the CPU 7 recognizes the identification data of a reserve pitcher character warming up at the bullpen corresponding to the selected pitcher name item. Thus, a pitcher character to get back from the bullpen to the bench is specified.

Then, the CPU 7 issues a command for getting the specified reserve pitcher character warming up at the bullpen back to the bench (i.e., the preparation pause command). The preparation pause command is used for causing a pitcher character having warmed up at the bullpen to take a break. Accordingly, the CPU 7 issues a character clear command for clearing the reserve pitcher character warming up at the bullpen from the bullpen screen 76. Then, a pitcher character corresponding to the identification data of a reserve pitcher character warming up at the bullpen corresponding to the selected pitcher name item, that is, the selected reserve pitcher character warming up at the bullpen is cleared from the bullpen screen 76 (Step S428 of FIG. 8C).

On the other hand, when the preparation pause command was not given (No in Step S427 of FIG. 8C), that is, when the third button 17c of the controller 17 was not pressed while the pitcher character name item was being selected, the CPU 7 determines if a command for causing a reserve pitcher character warming up at the bullpen to play on the mound in a baseball match event (i.e., the taking the mound in baseball match event command) was given (Step S429 of FIG. 8C). For example, the CPU 7 determines if the second button 17b of the controller 17 was pressed while the pitcher name item of a warming-up pitcher character displayed on the upper right part of the bullpen screen 76 was being selected. When the second button 17 was pressed while the pitcher name item was being selected (Yes in Step S429 of FIG. 8C), the CPU 7 recognizes the identification data of a reserve pitcher character warming up at the bullpen corresponding to the selected pitcher name item. Thus, it is determined which reserve pitcher character warming up at the bullpen is going to play on the mound in a baseball match event (Step S430 of FIG. 8C).

Next, the CPU 7 determines if a command for resuming a baseball match event was given (Step S431 of FIG. 8C). For example, the CPU 7 determines if an input button for resuming a baseball match event (e.g., the third button 17c of the controller 17) was pressed. When the third button 17c was pressed (Yes in Step S431 of FIG. 8C), the CPU 7 issues a command for switching the screen displayed on the television monitor 20 from the bullpen screen 76 to the baseball match screen 75. Accordingly, the CPU 7 resumes the suspended control for a baseball match event, and the baseball match screen 75 is displayed on the television monitor 20. Then, the CPU 7 re-executes the match-up processing between a pitcher character and a batter character (Step S432 of FIG. 8D).

Here, when there is a reserve character currently taking a break from warm-up at the bullpen, that is, when the preparation pause command was given (Yes in Step S427 of FIG. 8C), the preparation condition data JD of a reserve pitcher character currently taking a break from warm-up at the bullpen is changed to be smaller in proportion to the number of pitches released by a pitcher character currently on the mound (Step S433 of FIG. 8D). Specifically, as illustrated in FIG. 6, as the number of pitches released by a pitcher character currently on the mound is increased by two, the preparation condition data JD of a pitcher character currently taking a break from warm-up at the bullpen is decreased by one.

Also, when the suspended baseball match event was resumed (Step S432 of FIG. 8D), the CPU 7 executes processing of computing the number of pitches released by a pitcher character currently on the mound with respect to a batter character after a reserve pitcher character was instructed to take a break from warm-up at bullpen.

Also, in this case (Yes in Step S427 of FIG. 8C), the toughness data NT (IDh, 8) of a reserve pitcher character warming up at the bullpen is changed to be larger in proportion to the number of pitches released by a pitcher character currently on the mound (Step S434 of FIG. 8D). Specifically, as illustrated in FIG. 6, as the number of pitches released by a pitcher character currently on the mound is increased by five, the toughness data NT (IDh, 8) of the reserve pitcher character warming up at the bullpen is increased by one.

In general, when a pitcher character takes a break from warm-up at the bullpen, a preparation condition of the pitcher character (i.e., warm-up condition or readiness for pitching) will be worse. However, the pitcher recovers his toughness. With the above-mentioned processing, the impact of taking a break from warm-up on a pitcher character is thus evaluated in the baseball video game.

Here, when there is a pitcher character continuously warming up at the bullpen, the same processing as in Step S423 of FIG. 8C will be executed for the pitcher character. Its detailed explanation will be hereinafter omitted.

Furthermore, when the pitcher character selected through the bullpen screen 76 plays on the mound in a baseball match event, or when it is determined which reserve pitcher character warming up at the bullpen is going to play on the mound in a baseball match event (Yes in Step S429, and then Step S430 of FIG. 8C), the CPU 7 issues a command for causing the pitcher character selected through the bullpen screen 76 to play on the mound in a baseball match event (i.e., the taking the mound in baseball match event command). Accordingly, the pitcher character selected through the bullpen screen 76 is displayed on the baseball match screen 75 with the corresponding pitcher character's image data (Step S435 of FIG. 8D). In other words, a pitcher character currently on the mound is relieved by another pitcher character. Then, the CPU 7 consecutively executes the match-up between the relief pitcher character and a batter character (Step S436 of FIG. 8D).

Steps S433 to S435 illustrates an example case that a reserve pitcher character takes a break from warm-up at the bullpen and a pitcher character on the mound is relieved by another pitcher character.

However, when a reserve pitcher character takes a break from warm-up at the bullpen but a pitcher character on the mound is not relieved by another pitcher character, processing in Steps S433 and S434 are executed and processing in Step S435 is not executed.

Also, when a pitcher character does not take a break from warm-up at the bullpen but a pitcher character currently on the mound is relieved by another pitcher character, processing in Steps S433 and S434 are not executed but processing in Step S435 is executed.

Furthermore, when a reserve pitcher character does not take a break from warm-up at the bullpen and a pitcher character on the mound is not relieved by another pitcher character, processing in Steps S433 to S435 are not executed but processing in Step S436 is executed.

Next, the CPU 7 determines if a baseball match event was finished (Step S437 of FIG. 8D). For example, it is herein determined by the CPU 7 if a flag is turned on for indicating finish of a baseball match event. In other words, the CPU 7 determines if the flag value is “1”.

When the CPU 7 determined that the baseball match event had not been finished yet, that is, when the flag value was not “1” (the flag value was “0”, No in Step S437 of FIG. 8D), the CPU 7 re-executes processing in Step S406 of FIG. 8A. On the other hand, when the CPU 7 determined that the baseball match event was finished, that is, when the flag value was “1” (Yes in Step S437 of FIG. 8D), the CPU 7 executes processing of terminating the baseball match event (e.g., processing of storing a variety of data in the RAM 12, Step S438 of FIG. 8D).

The above-mentioned embodiment does not specifically describe processing of a match-up between a pitcher character and a batter character to be executed when the baseball match event was resumed (Steps S419 of FIG. 8B and S432 of FIG. 8D). However, even when the baseball match event was resumed, the CPU 7 executes similar processing as in Steps S406 to S409 and Step S439.

Thus, according to the present embodiment, it is possible to cause the reserve pitcher character 71a to warm up at the bullpen by giving the reserve pitcher character 71 a command of starting preparation for replacement (i.e., the preparation start command) while the pitcher character 70 plays on the mound in a baseball match event.

Also, it is possible to cause the reserve pitcher character 71a warming up at the bullpen to relieve the pitcher character 70 on the mound by giving the reserve pitcher character 71a a baseball match event participation command while the reserve pitcher character 71a warms up at the bullpen.

Also, it is possible to cause the reserve pitcher character 71a warming up at the bullpen to go back to the bench by giving the reserve pitcher character 71a a preparation pause command. In other words, it is possible to cause the reserve pitcher character 71a warming up at the bullpen for replacement in a baseball match event to take a break from the warm-up.

Also, when a command of starting warming up for replacement (i.e., the preparation start command) is given to the reserve pitcher character 71a, the warm-up gauge 100 is displayed on the bullpen screen 76 for showing a preparation condition of the reserve pitcher character 71a. Accordingly, a game player is capable of judging a preparation level of the reserve pitcher character 71a by watching the warm-up gauge 100.

Also, a game player is capable of predicting a preparation condition of the reserve pitcher character 71a warming up at the bullpen by grasping the number of pitches released by a pitcher character on the mound after the preparation start command was given to the reserve pitcher character 71a. For example, a game player is capable of predicting a preparation condition of the reserve pitcher character 71a warming up at the bullpen by grasping the number of pitches released by the pitcher character 70 on the mound, even when the game player executes the match-up mode in a baseball match event while the reserve pitcher character 71a warming up at the bullpen is not displayed on the screen.

Also, a game player is not capable of improving a preparation condition of the reserve pitcher character 71a warming up at the bullpen by repeatedly causing the pitcher character 70 on the mound to make a pickoff throw. In other words, a game player is not capable of improving a preparation condition of the reserve pitcher character 71a warming up at the bullpen by repeatedly causing the pitcher character 70 on the mound to make a pickoff throw without a match-up with a batter character 80. According to the present embodiment, a preparation condition of the reserve pitcher character 71a warming up at the bullpen is thus changed with a method departing from the original form of the baseball game.

Also, when a preparation condition of the reserve pitcher character 71a reaches a completely prepared condition (JD=10) and then the reserve pitcher character 71a is caused to release the ball object, the reserve pitcher character 71a is tired. For example, an ability property of the reserve pitcher character 71a (e.g., the toughness property) is lowered. Therefore, a game player needs to play the match-up mode not only by simply giving the reserve pitcher character 71 the preparation start command but also by always considering a preparation level of the reserve pitcher character 71a warming up at the bullpen even after giving the reserve pitcher character 71 the preparation start command. When a game player thus plays the baseball video game, the game player enjoys it as a more realistic baseball video game.

### Other Example Embodiment

(a) In the above-mentioned embodiment, the home video game device is used as an example of a computer that the game program is allowed to be applied. However, the game device is not limited to the above-mentioned embodiment. The game device may be applied to a game device that a monitor is separately provided, a monitor-integrated game device, a personal computer or a workstation functioning as a game device when a game program is executed therein, and the like, as well.

(b) The present invention includes a program for executing the above-mentioned game and a computer-readable recording medium storing the program. For example, a computer-readable flexible disk, a semiconductor memory, a CD-ROM, a DVD, a MO, a ROM cassette, and the like may be suggested as the recording medium other than the cartridge.

### General Interpretation

A used herein, the following directional terms “forward, rearward, above, downward, vertical, horizontal, below and transverse” as well as any other similar directional terms refer to those directions of a device equipped with the present invention. Accordingly, these terms, as utilized to describe aspects of the present invention, should be interpreted relative to a device equipped with the present invention.

The term “configured” as used herein to describe a component, section or part of a device includes hardware and/or software that is constructed and/or programmed to carry out the desired function.

Terms that are expressed as “means-plus function” in the claims should include any structure that can be utilized to carry out the function of that part of the present invention.

The term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applied to words having similar meanings such as the terms, “including,” “having,” and their derivatives. Also, the term “part,” “section,” “portion,” “member,” or “element” when used in the singular can have the dual meaning of a single part or a plurality of parts.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present-invention are provided for illustration only, and not for the purpose of limiting the invention as defined by the appended claims and their equivalents. Thus, the scope of the invention is not limited to the disclosed embodiments.

What is claimed is:

1. A computer readable medium storing a computer program for a video game in which a user operates characters displayed on an image display unit, the computer program comprising:
code for controlling a match-up event in the video game;
code for displaying a first character in the match-up event on a first screen;
code for recognizing a second character standing by for participating in the match-up event;
code for issuing a preparation start command for the second character to start the preparation for participating in the match-up event; and
code for displaying on a second screen the second character preparing for participating in the match-up event, when the preparation start command is issued.

2. The computer readable medium according to claim 1, the computer program further comprising
code for issuing a match-up event participation command for the second character to participate in the match-up event, and
code for displaying the second character on the first screen, when the match-up event participation command is issued.

3. The computer readable medium according to claim 1, the computer program further comprising
code for issuing a preparation pause command for the second character to pause the preparation, and
code for issuing a character clearance command to clear the second character preparing from the second screen, when the preparation pause command is issued.

4. The computer readable medium according to claim 1, the computer program further comprising
code for recognizing a preparation condition of the second character in the preparation with second character's preparation condition data, when the preparation start command is issued, and
code for displaying the preparation condition of the second character on at least one of the first screen and the second screen.

5. The computer readable medium according to claim 4, the computer program further comprising
code for changing the preparation condition data on the basis of a motion of the first character.

6. The computer readable medium according to claim 5, wherein
the first character is a pitcher character on a pitching mound in a baseball video game,
the second character is a reserve pitcher character in the baseball video game, and
the preparation condition data is changed based on an assumption that the reserve pitcher character pitches at the same frequency as the pitcher character pitches on the pitching mound in the same period of time.

7. The computer readable medium according to claim 5, wherein
the first character is a pitcher character on a pitching mound in a baseball video game,
the second character is a reserve pitcher character in the baseball video game, and
the motion is a pitching motion to pitch a ball to a batter character or a pickoff motion to throw the ball to a fielder character,
when the motion is the pitching motion, the preparation condition data is changed on the basis of the pitching motion of the pitcher character on the mound, and
when the motion is the pickoff motion, the preparation condition data is not changed.

8. The computer readable medium according to claim 4, the computer program further comprising
code for issuing a preparation pause command for the second character to pause the preparation, and
code for changing the preparation condition data on the basis of a motion of the first character after the preparation pause command is issued.

9. The computer readable medium according to claim 4, the computer program further comprising
code for recognizing a property of the second character preparing for participating in the match-up event with second character's property data, and
code for changing the second character's property data in conjunction with a motion of the second character when the preparation condition data reaches a predetermine value.

10. A video game device for a video game, comprising:
match-up event control means for controlling a match-up event in the video game;
first display means for displaying a first character in the match-up event on a first screen;
second character recognition means for recognizing a second character standing by for participating in the match-up event;
preparation start command issue means for issuing a preparation start command for the second character to start the preparation for participating in the match-up event; and
second display means for displaying n a second screen the second character preparing for participating in the match-up event, when the preparation start command is issued.

11. A method for controlling a computer for a video game in which a user operates characters displayed on an image display unit, the method comprising:
controlling a match-up event in the game;
displaying a first character in the match-up event on a first screen;
recognizing a second character standing by for participating in the match-up event;
issuing a preparation start command for the second character to start the preparation for participating in the match-up event; and
displaying on a second screen the second character preparing for participating in the match-up event, when the preparation start command is issued.
